(19) United States
(12) Patent Application Publication
(10) Pub. No.: US 2009/0040191 A1
(43) Pub. Date: Feb. 12, 2009

(54) CAPACITIVE TOUCH SENSOR WITH CONDUCTIVE TRACE LINES IN BONDING REGION

(75) Inventors: Tony TONG, Elk Grove, CA (US); James (Jinwha) JUNG, San Jose, CA (US)

Correspondence Address: INGRASSIA FISHER & LORENZ, P.C. (SYNA), 7010 E. Cochise Road, SCOTTSDALE, AZ, 85253, US

(73) Assignee: SYNAPTICS INCORPORATED, Santa Clara, CA (US)

(21) Appl. No.: 11/835,876

(22) Filed: Aug. 8, 2007

(51) Int. Cl. G06F 3/045

(52) U.S. Cl. 345/174; 178/18.06

(57) ABSTRACT

Methods and apparatus are provided for a capacitive touch sensor including a circuit substrate (which may be a flexible substrate) having a touch sensor controller coupled to a plurality of contacts through a plurality of conductive traces. The contacts are formed on a first (bottom) side of the circuit substrate while the conductive traces are formed on a second (top) side of the circuit substrate, but are ohmically (electrically) coupled to the contacts through the use of conductive vias. This arrangement of conductive traces, vias and contacts allows the conductive traces to reside over the contacts and within the bonding region resulting in an improvement of over fifty percent in wasted space as compared to conventional touch sensors.

### FIELD OF THE INVENTION

The present invention generally relates to touch sensor devices for use in various electronic devices and more particularly relates to capacitive touch sensor devices that must be size optimized for use in small electronic devices.

### BACKGROUND OF THE INVENTION

Touch sensor devices (also commonly called touch pads) are widely used in a variety of electronic systems. A capacitive touch sensor device is typically a sensitive surface that uses absolute capacitance or detects a change in capacitance to determine the presence, location and or motion of one or more fingers, styli, and/or other objects. The capacitive touch sensor device, together with a finger or other object provides an input to the electronic system. For example, capacitive touch sensor devices are used as input devices for laptop or notebook computers.

Capacitive touch sensor devices are also used in smaller devices, such as personal digital assistants (PDAs) and communication devices such as wireless telephones and text messaging devices. Increasingly, capacitive touch sensor devices are used in multimedia devices, such as CD, DVD, MP3 or other media players. Many electronic devices include a user interface, or UI, and an input device for interacting with the UI. A typical UI includes a screen for displaying graphical and/or textual elements. The increasing use of this type of UI has led to a rising demand for touch sensor devices as pointing devices. In these applications the capacitive touch sensor device can function as a cursor control device, selection device, scrolling device, character/handwriting input device, menu navigation device, gaming input device, button input device, keyboard and/or other input device.

Past designs of touch sensors have had several notable limitations. One limitation has been the relative inflexibility of some designs to conform to the limited spaces available in some applications. For example, some designs have required large and inflexible circuit boards that prevented the touch sensor from being used in small, low profile, or irregular spaces.

Accordingly, it is desirable to optimize the size and space required to implement a capacitive touch sensor in various electronic devices. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

An apparatus is provided for capacitive touch sensing by coupling a first plurality of contacts formed within a bonding region on the first side of a circuit substrate to a first plurality of conductive traces formed over the bonding region on the second side of the circuit substrate with each of the first plurality of conductive traces being ohmically coupled to one of the first plurality of contacts through a first plurality of vias so that a touch sensor controller affixed to the circuit substrate and coupled to the first plurality of contacts through the first plurality of conductive traces can receive object position information from a plurality of sensing electrodes couple to the first plurality of contacts by a second plurality of contacts, the first plurality of conductive traces configured on a sensor substrate to detect an object is proximate to the sensing electrodes capacitively.

A method is provided for making a capacitive touch sensor by electrically coupling a touch sensor controller to a first plurality of conductive traces formed over a bonding region of a circuit substrate having a first plurality of contacts formed within the bonding region, each of the first plurality of conductive traces ohmically coupled to one of the first plurality of contacts through a first plurality of vias and electrically coupling the first plurality of contacts on the circuit substrate to a second plurality of contacts formed within the bonding region on a sensor substrate, the sensor substrate and having a plurality of sensing electrodes configured when an object is proximate to the sensing electrodes capacitively, the plurality of sensing electrodes thereby communicating position information of the object to the touch sensor controller though the first plurality of contacts, the first plurality of vias, the first plurality of conductive traces, and the second plurality of contacts.

### BRIEF DESCRIPTION OF THE DRAWINGS

The present invention will hereinafter be described in conjunction with the following drawing figures, wherein like numerals denote like elements, and

FIG. 1 is a block diagram of a capacitive touch sensor used by an electronic device according to a preferred embodiment of the present invention;

FIGS. 2 and 3 are schematic views of a touch sensor device in accordance with the prior art;

FIG. 4 is a cut-away view of a capacitive touch sensor in accordance with a preferred embodiment of the present invention;

FIG. 5 is an assembled view of a capacitive touch sensor in accordance with a preferred embodiment of the present invention.

FIG. 6 is an assembled view of a capacitive touch sensor in accordance with another embodiment of the present invention.

FIG. 7 is a cut-away view of a capacitive touch sensor in accordance with another embodiment of the present invention;

FIG. 8 is a cut-away view of a capacitive touch sensor in accordance with another embodiment of the present invention; and

FIG. 9 is a perspective view of a capacitive touch sensor in accordance with another embodiment of the present invention.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

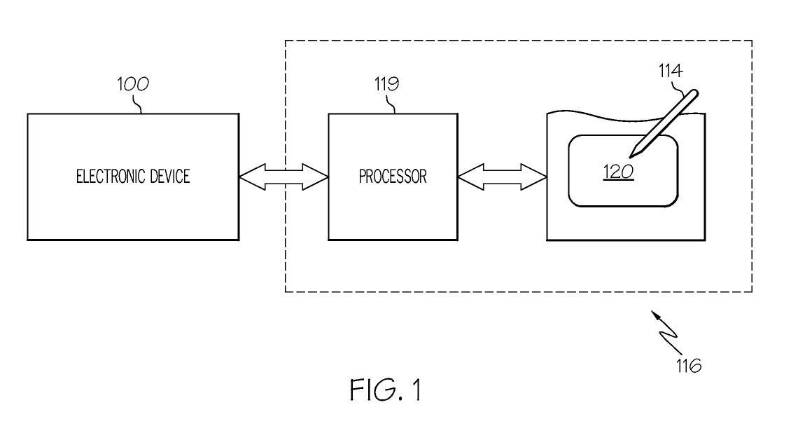

Referring to FIG. 1, a block diagram of an exemplary electronic device 100 is shown coupled to a capacitive touch sensor device 116. As will be apparent to those skilled in the art, electronic device 100 may be any type of personal computer, portable computer (laptop or tablet), workstation, personal digital assistant, gaming device, communication device (including wireless phones and messaging devices), media device, including recorders and players (including televisions, cable boxes, music players, and video players) or other device capable of accepting input from a user. Accordingly, the various embodiments of electronic device 100 may include any type of processor, memory or display. Additionally, the elements of electronic device 100 may communicate via a bus, network or other wired or wireless interconnection. For example the electronic device 100 can be connected to the capacitive touch sensor device 116 through any type of interface or connection, including I2C, SPI, PS/2, Universal Serial Bus (USB), Bluetooth, RF, IRDA, or any other type of wired or wireless connection to list several non-limiting examples.

Capacitive touch sensor device 116 includes a touch sensor processor 119 and a sensing region 120. Capacitive touch sensor device 116 is sensitive to the position of one or more input objects, such as a stylus 114, finger and/or other input object within the sensing region 120. “Sensing region” 120 as used herein is intended to broadly encompass any space above, below, around, in and/or near the capacitive touch sensor device 116 wherein the capacitive touch sensor is able to detect a position or motion of the object. In a conventional embodiment, sensing region 120 extends from the surface of the sensor in one or more directions for a distance into space until signal-to-noise ratios prevent object detection. This distance may be on the order of less than a millimeter, millimeters, centimeters, or more, and may vary significantly with the type of position sensing technology used and the accuracy desired. Accordingly, the planarity, size, shape and exact locations of the particular sensing region 120 will vary widely from embodiment to embodiment.

In operation, capacitive touch sensor device 116 suitably detects positional information of stylus 114, finger or other input object(s) within sensing region 120, and using the touch sensor processor 119, provides electrical or electronic indicia of the position to the electronic device 100. The electronic device 100 appropriately processes the indicia to accept inputs from the user to control the electronic device or cause an orientation change on a display to occur, as will be discussed in greater detail below.

The capacitive touch sensor device 116 applies a voltage to create an electric field across a sensing surface. A capacitive touch sensor device 116 would then detect the position of an object by detecting capacitance (e.g., changes in capacitance or absolute capacitance) that result from the location of the object. The touch sensor processor 119 is coupled to the sensor and the electronic device 100. In general, the touch sensor processor 119 receives electrical signals from the sensor, processes the electrical signals, and communicates with the electronic device 100. The touch sensor processor 119 can perform a variety of processes on the signals received from the sensor to implement the proximity sensor device 116. For example, the touch sensor processor 119 can select or connect individual sensor electrodes, detect presence/proximity, calculate position or motion information, and report a position or motion when a threshold is reached, and/or interpret and wait for a valid tap/stroke/character/button/gesture sequence before reporting it to the electronic device 100, or indicating it to the user. The touch sensor processor 119 can also determine when certain types or combinations of object motions occur proximate the sensor.

In this specification, the term “processor” is defined to include one or more processing elements that are adapted to perform the recited operations. Thus, the touch sensor processor 119 can comprise all or part of one or more integrated circuits, firmware code, and/or software code that receive electrical signals from the sensor and communicate with the electronic device 100. Furthermore, the touch sensor processor 119 can be physically separate from the part of the electronic device 100 that it communicates with, or the touch sensor processor 119 can be implemented integrally with that part of the electronic device 100. For example, the touch sensor processor 119 can reside at least partially on a processor performing other functions for the electronic device 100 system aside from implementing the touch sensor device 116.

In addition, the terms “contact” and “pad” are used interchangeably throughout this specification and they are intended to broadly be any suitable electrical (ohmic) connection that will conduct signals to conductors coupled to the contracts or pads.

Also, the phrases “position information” or “positional information” as used herein is intended to broadly encompass absolute and relative position-type information, and also other types of spatial-domain information such as velocity, acceleration, and the like, including measurement of presence or motion in one or more directions. Various forms of positional information may also include time history components, as in the case of gesture recognition and the like. Accordingly, capacitive touch sensor devices can appropriately detect more than the mere presence or absence of an object and may encompass a broad range of equivalents.

Finally, as the term is used in this application, the term “electronic device” broadly refers to any type of device that communicates with touch sensor device 116. The electronic device 100 could thus comprise any type of device or devices in which a touch sensor device can be implemented in or coupled to. Furthermore, the touch sensor device could be implemented as part of the electronic device 100, or coupled to the electronic device using any suitable technique. As non-limiting examples the electronic device 100 could thus comprise any type of computing device, media player, communication device or gaming device. In some cases the electronic device 100 is itself a peripheral to a larger system. For example, the electronic device 100 could be a data input or output device, such as a remote control or display device, that communicates with a computer or media system (e.g., remote control for television) using a suitable wired or wireless technique. It should also be noted that the various elements (display screen, processor, memory, etc.) of the electronic device 100 could be implemented as part of an overall system, as part of the proximity sensor device, or as a combination thereof. Additionally, the electronic device 100 could be a host or a client to the touch sensor device 116.

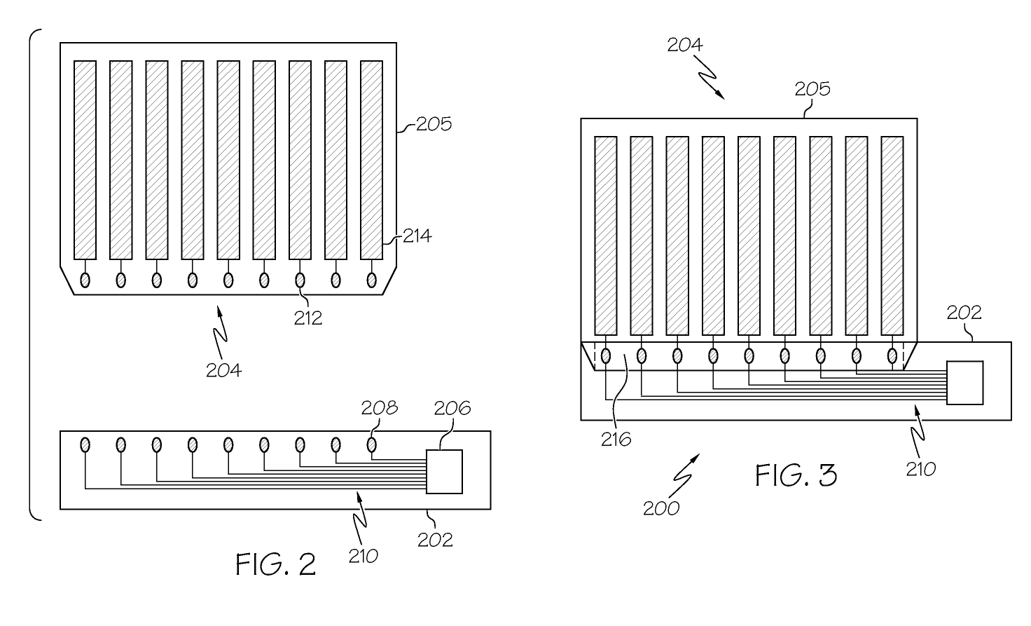

Referring now to FIGS. 2 and 3, a conventional (prior art) touch sensor device 200 is illustrated. The conventional touch sensor device 200 includes a flexible circuit substrate 202 and a sensor component 204. FIG. 2 illustrates the flexible circuit substrate 202 and sensor component 204 separately, while FIG. 3 illustrates the substrates coupled together as they may be in a completed touch sensor device.

In the illustrated conventional embodiment, the flexible circuit substrate 202 includes a touch sensor controller 206, the touch sensor controller 206 coupled to a plurality of pads 208 through a plurality of conductors 210. The sensor component 204 includes a substrate 205 and a plurality of sensing elements 214 for detecting an object proximate to the sensing elements 214. Each of the plurality of sensing elements 214 is coupled to a pad 212. When assembled together and in operation, the touch sensor device 200 detects objects that are proximate to the sensing elements 214, and, using the pads 208 and 212, conductors 210, and controller 206, processes and communicates information regarding the position and/or motion of the proximate object.

The pads 208 and 212 are electrically connected together in a bonding region 216. Typically, heat and pressure are applied during the manufacturing process to cause a bonding agent, such as a conductive adhesive, to ohmically couple the pads 208 and 212 together. One application of such a bonding process is referred to by those skilled in the art as a “hot bar” process and generally, the area in which the hot bar is applied to ohmically couple the pads 208 and 212 is referred to as the bonding region.

As can be seen in FIG. 3, in conventional touch sensors, the plurality of conductors 210 are entirely outside the bonding region 216. While acceptable in some applications, the conventional touch sensor illustrated in FIG. 3 can't be used in small or miniature touch sensor applications because it is too large and the spacing between the plurality of conductors 210 can't be further reduced without also reducing reliability by the increased likelihood of an electrical short or increased cross-talk between adjacent conductors.

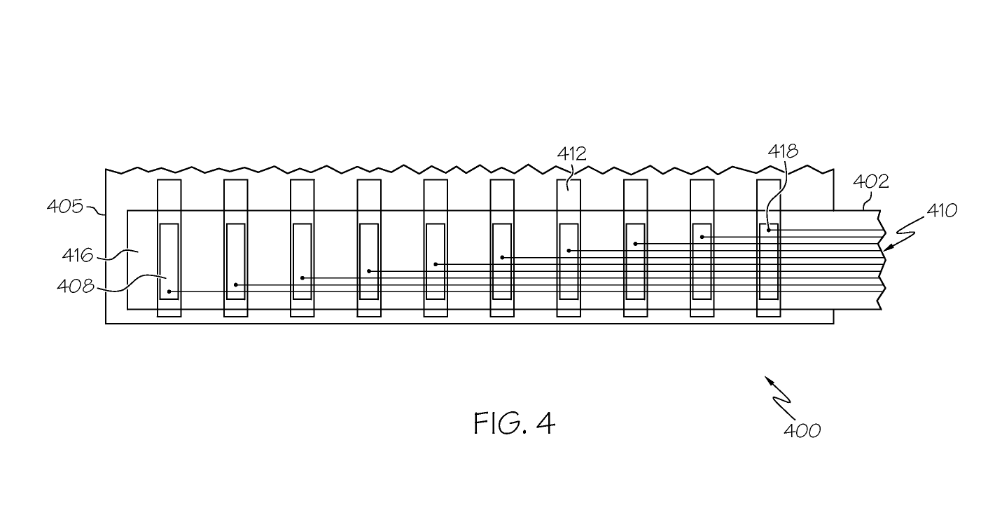

Referring to FIG. 4, a cut-away view of a capacitive touch sensor device 400 is shown to illustrate the fundamental concept of the present invention. The inventive touch sensor device 400 includes a circuit substrate 402 (which may be a flexible substrate) includes a touch sensor controller (not shown in this cut-away view) coupled to a plurality of contacts 408 through a plurality of conductive traces 410. The contacts 408 are formed on a first (bottom) side of the circuit substrate 402 while the conductive traces 410 are formed on a second (top) side of the circuit substrate 402, but are ohmically (electrically) coupled to the contacts through the use of conductive vias 418. As can be seen in FIG. 4, this arrangement of conductive traces, vias and contacts allows the conductive traces 410 to reside over the contacts and within the bonding region 416 resulting in an improvement of over fifty percent in wasted space as compared to conventional touch sensors.

The sensor component includes a substrate 405 and a plurality of sensing elements (not shown in this cut-away view) for detecting an object proximate to the sensing elements. Each of the plurality of sensing elements is coupled to a pad 412. When assembled together and in operation, the capacitive touch sensor device 400 detects objects that are proximate to the sensing elements, and using the pads 408 and 412, conductors 410, vias 418 the touch sensor controller is able to process and communicate information regarding the position and/or motion of the proximate object.

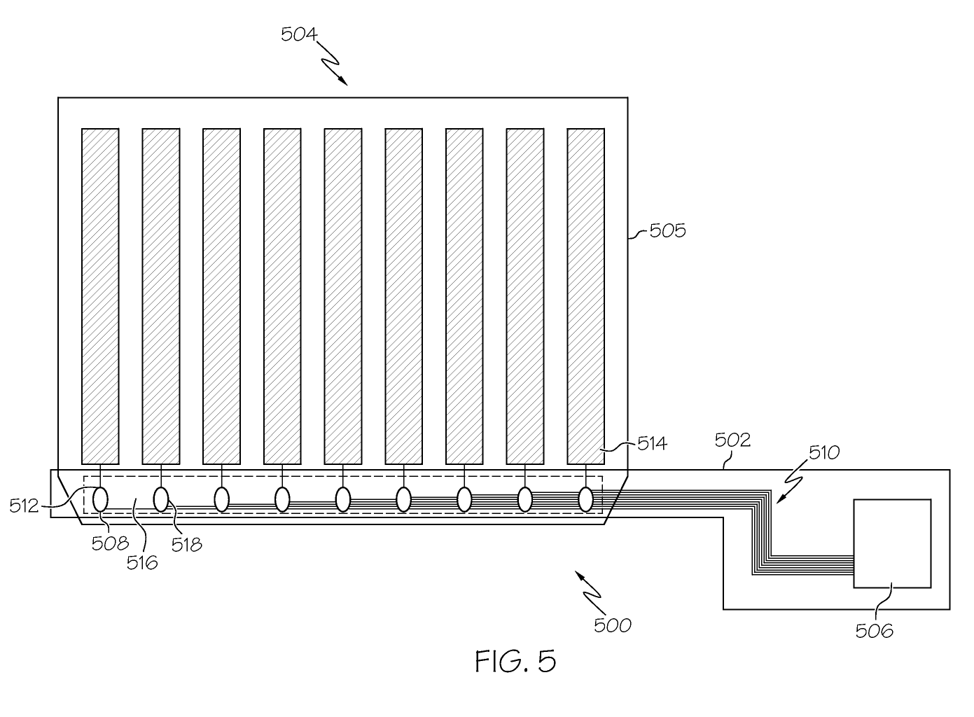

Referring to FIG. 5, an assembled view of a capacitive touch sensor device 500 is shown to include a circuit substrate 502 (which may be a flexible substrate) having a touch sensor controller 506 coupled to a plurality of contacts 508 through a plurality of conductive traces 510. As discussed in context with FIG. 4, the contacts 508 are formed on a first (bottom) side of the circuit substrate 502 while the conductive traces 510 are formed on a second (top) side of the circuit substrate 502, but are ohmically (electrically) coupled to the contacts through the use of conductive vias 518. As can be seen, the conductive traces, vias and contacts allow the conductive traces 510 to reside over the contacts and within the bonding region 516. The sensor component includes a substrate 505 and a plurality of sensing elements 514 for detecting an object proximate to the sensing elements. In the preferred embodiment the sensor substrate is transparent (or at least substantially transparent). Each of the plurality of sensing elements is coupled to a pad 512. When assembled together and in operation, the capacitive touch sensor device 500 detects objects that are proximate to the sensing elements, and using the pads 508 and 512, conductors 510, vias 518 the touch sensor controller 506 is able to process and communicate information regarding the position and/or motion of the proximate object.

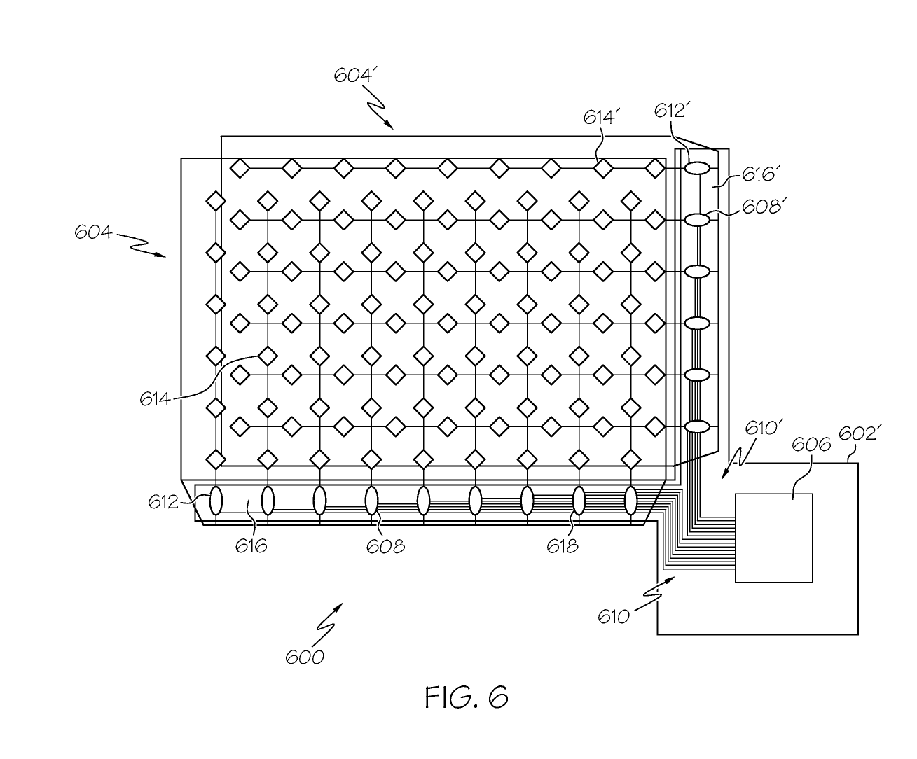

Referring to FIG. 6, an assembled view of a two-dimensional sensing capacitive touch sensor device 600 is shown to include a circuit substrate 602 (which may be a flexible substrate) having a touch sensor controller 606 coupled to a plurality of contacts 608 through a plurality of conductive traces 610. As discussed in context with FIG. 5, the contacts 608 are formed on a first (bottom) side of the circuit substrate 602 while the conductive traces 610 are formed on a second (top) side of the circuit substrate 602, but are ohmically (electrically) coupled to the contacts through the use of conductive vias 618. In this embodiment there are two sensor substrates 604 and 604′ each having a plurality of sensing elements 614 and 614′ for detecting an object proximate to the sensing elements. Each of the plurality of sensing elements is coupled to a pad 612 and 612′. When assembled together and in operation, the capacitive touch sensor device 600 has two bonding regions 616 and 616′ where conductive traces 610 and 610′ reside over the respective bonding regions and are ohmically coupled to contacts 608 and 608′ by vias 618 and 618′. In this way, the capacitive touch sensor 600 detects objects that are proximate to the sensing elements 614 and 614′, and using the pads 608, 608′, 612 and 612′, conductors 610 and 610′ and the vias 618 and 618′ the touch sensor controller 606 is able to process and communicate information regarding the position and/or motion of the proximate object.

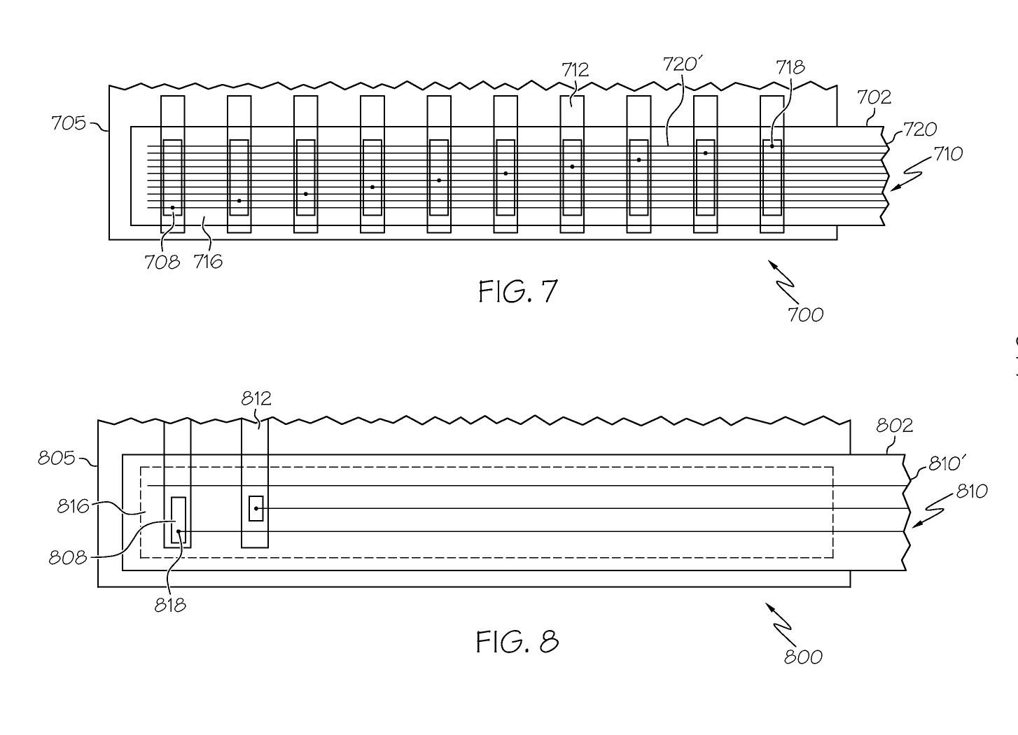

Referring to FIG. 7, a cut-away view of a capacitive touch sensor device 700 is shown to illustrate another embodiment of the present invention particularly useful when the circuit substrate 702 is flexible. The inventive touch sensor device 700 includes a circuit substrate 702 includes a touch sensor controller (not shown in this cut-away view) coupled to a plurality of contacts 708 through a plurality of conductive traces 710. The contacts 708 are formed on a first (bottom) side of the circuit substrate 702 while the conductive traces 710 are formed on a second (top) side of the circuit substrate 702, but are ohmically (electrically) coupled to the contacts through the use of conductive vias 718. In this embodiment, the conductive traces 710 do not end at the respective vias 718 coupling the conductive traces to the respective contacts 708, but continue across the bonding area. For example, conductive trace 720 has a portion thereof 720′ that continues past the via 718. This provides additional metallization for increased stiffness and flatness of the flexible circuit substrate 702 which can improve bonding between the contacts 708 and 712 within the bonding area 716.

Referring now to FIG. 8, a cut-away view of a capacitive touch sensor device 800 is shown to illustrate another embodiment of the present invention. The inventive touch sensor device 800 includes a circuit substrate 802 (which may be a flexible substrate) includes a touch sensor controller (not shown in this cut-away view) coupled to a plurality of contacts 808 through a plurality of conductive traces 810. The contacts 808 are formed on a first (bottom) side of the circuit substrate 802 while the conductive traces 810 are formed on a second (top) side of the circuit substrate 802, but are ohmically (electrically) coupled to the contacts through the use of conductive vias 818. As can be seen in FIG. 8, this arrangement of conductive traces, vias and contacts allows the conductive traces 810 to reside over the contacts and within the bonding region 816 resulting in an improvement of over fifty percent in wasted space as compared to conventional touch sensors. Additionally, however, in this embodiment, additional conductive traces (one shown) 810′ reside within the bonding region 816, but are not ohmically coupled to any contacts 808. In one embodiment, the conductive trace 810′ could be coupled to a constant electrical potential (e.g., circuit ground) or a varying electrical potential. As discussed in connection with FIG. 7, the extra metallization provides increased stiffness and flatness of the flexible circuit substrate 802 which can improve bonding between the contacts 808 and 812 within the bonding area 816.

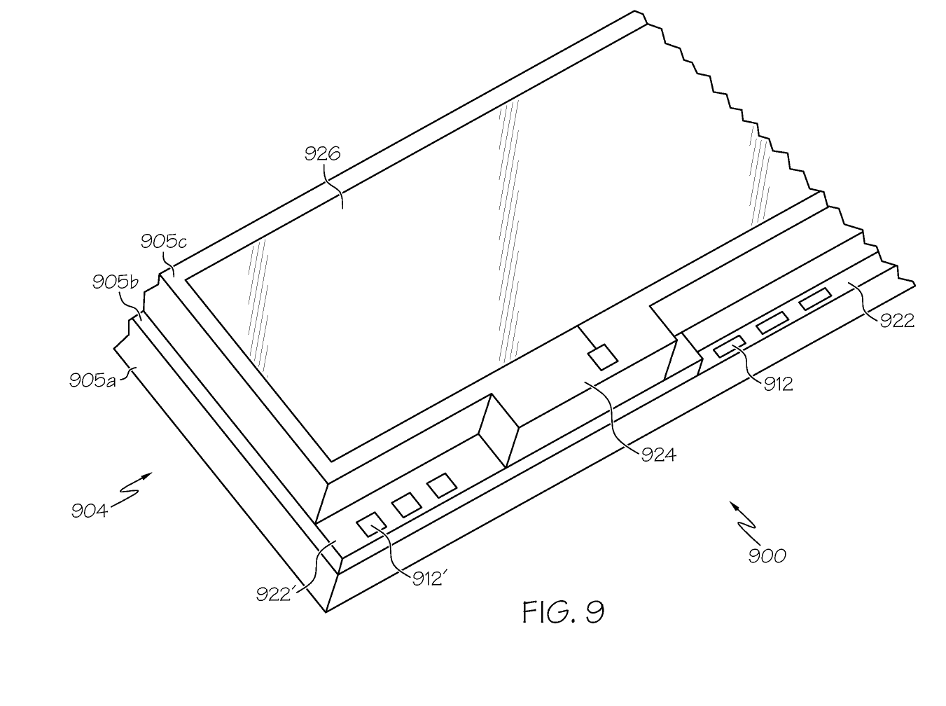

Referring now to FIG. 9, sensor component 904 includes a multi-layer substrate comprised of a first layer 905a, an intermediate layer 905b and a third layer 905c. In some embodiments, the third layer 905c may include a ground plane 926 over some or all of the top surface for shielding signals (e.g., EMI or noise) from the conductors of the first and intermediate layers. Generally, it is preferred that the “X” direction conductive traces (not shown) would reside on the first layer 905a and the “Y” direction conductive traces (not shown) can be formed on the intermediate layer 905b. In this embodiment, the present invention contemplates that a portion of the third layer 905c and the intermediate layer 905b are removed (by cutting or other conventional process known in the art) forming a sensor component 904 having a first level 922 where contacts 912 are accessible on the first layer 905a, a second level 922′ where contacts 912′ are accessible on the intermediate layer 905b and a third level 924 having a contact for the ground plane 926. Due to the nature of the circuit substrate being flexible, it can form across the first level 922, second level 922′ and third level 924 to ohmically couple the plurality of conductive traces and contacts (not shown) so that the plurality of sensing elements can detecting an object proximate to the sensing elements and send positional information to the touch sensor controller (not shown).

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A capacitive touch sensor, comprising:
a circuit substrate having a first side and a second side, and having a first plurality of contacts formed within a bonding region on the first side and a first plurality of conductive traces formed over the bonding region on the second side, each of the first plurality of conductive traces ohmically coupled to one of the first plurality of contacts through a first plurality of vias;
a touch sensor controller, the touch sensor controller coupled to the circuit substrate and coupled to the first plurality of contacts through the first plurality of conductive traces and the first plurality of vias; and
a sensor substrate, the sensor substrate, including a second plurality of contacts and a plurality of sensing electrodes configured to detect an object proximate to the sensing electrodes capacitively to facilitate detection of the object by the capacitive touch sensor controller, the plurality of sensing electrodes coupled to the touch sensor controller through the first plurality of contacts, the first plurality of vias, the first plurality of conductive traces, and the second plurality of contacts;
wherein at least one of the circuit substrate and sensor substrate is flexible.

2. The capacitive touch sensor of claim 1, wherein the sensor substrate is flexible.

3. The capacitive touch sensor of claim 1, wherein the circuit substrate is flexible.

4. The capacitive touch sensor of claim 1, which includes at least one circuit trace ohmically coupled to a contact, wherein a portion of said circuit trace extends beyond a coupling point of said circuit trace and said contact.

5. The capacitive touch sensor of claim 1, wherein at least one of the plurality of conductive traces overlaps at least one contact in the bonding region and is not ohmically coupled to any contacts in the bonding region.

6. The capacitive touch sensor of claim 5, wherein the conductive trace not ohmically coupled to any contact in the bonding region is ohmically coupled to a constant electrical potential.

7. The capacitive touch sensor of claim 5, wherein the conductive trace not ohmically coupled to any contact in the bonding region is ohmically coupled to a varying electrical potential.

8. The capacitive touch sensor of claim 1, wherein the sensor substrate is substantially transparent.

9. The capacitive touch sensor of claim 1, wherein at least some of the first plurality of conductive traces are formed at least partially on the first side of the circuit substrate within the bonding region.

10. The capacitive touch sensor of claim 1, wherein the circuit substrate comprises a multiple layer flexible circuit substrate including an intermediate layer on which at least some of the first plurality of conductive traces are formed.

11. The capacitive touch sensor of claim 10, wherein a ground plane is formed on one of the layers.

12. The capacitive touch sensor of claim 10, wherein a second plurality of conductive traces is formed on the intermediate layer orthogonal to the first plurality of conductive traces.

13. The capacitive touch sensor of claim 3, wherein the second plurality of contacts are formed on a first and a second level of the sensor substrate within the bonding region and ohmically coupled to the first plurality of contacts by the flexible circuit substrate.

14. The capacitive touch sensor of claim 1, wherein the sensor substrate, the circuit substrate and sensor controller are operably coupled to an electronic device chosen from the group of: cellular telephone, cordless telephone, media storage and playback device, computer and electronic game.

15. A method for making a capacitive touch sensor, comprising the steps of:
electrically coupling a touch sensor controller to a first plurality of conductive traces formed over a bonding region of a circuit substrate having a first plurality of contacts formed within the bonding region, each of the first plurality of conductive traces ohmically coupled to one of the first plurality of contacts through a first plurality of vias; and
electrically coupling the first plurality of contacts on the circuit substrate to a second plurality of contacts formed within the bonding region on a sensor substrate, the sensor substrate having a plurality of sensing electrodes configured to detect an object proximate to the sensing electrodes capacitively, the plurality of sensing electrodes thereby communicating position information of the object to the touch sensor controller though the first plurality of contacts, the first plurality of vias, the first plurality of conductive traces, and the second plurality of contacts.

16. The method of claim 15, which includes the step of forming the circuit substrate over first and second levels of the sensor substrate within the bonding region to ohmically couple the first plurality of contacts to the second plurality of contacts residing on the first and second levels of the sensor substrate.

17. The method of claim 15, wherein the step of electrically coupling the touch sensor controller to the first plurality of conductive traces includes at least one of the plurality of conductive traces overlapping at least one contact in the bonding region and not ohmically coupled to the touch sensor controller or any contacts in the bonding region.

18. The method of claim 17, further comprising the step of coupling the conductive trace not coupled to any contact of the capacitive touch sensor to a constant electrical potential.

19. The method of claim 17, further comprising the step of coupling the conductive trace not coupled to any contact of the capacitive touch sensor to a varying electrical potential.

20. A method for assembling a capacitive touch sensor into an electronic device, comprising the steps of:
providing an area within a housing or case of the electronic device to receive a capacitive touch sensor;
electrically coupling a touch sensor controller to a first plurality of conductive traces disposed over a bonding region of a circuit substrate having a first plurality of contacts formed within the bonding region, each of the first plurality of conductive traces ohmically coupled to one of the first plurality of contacts through a first plurality of vias; and
electrically coupling the first plurality of contacts on the circuit substrate to a second plurality of contacts formed within the bonding region on a sensor substrate, the sensor substrate having a plurality of sensing electrodes configured to detect an object proximate to the sensing electrodes capacitively, the plurality of sensing electrodes thereby communicating position information of the object to the touch sensor controller though the first plurality of contacts, the first plurality of vias, the first plurality of conductive traces, and the second plurality of contacts; and
electrically coupling the touch sensor controller to other electronics within the electronic device such that the position information of the object can be processed by the other electronics to control the electronic device or be displayed by the electronic device.
